(19) United States
(12) Patent Application Publication
(10) Pub. No.: US 2007/0159132 A1
(43) Pub. Date: Jul. 12, 2007

(54) Battery charger for vehicle for charging power hand tool

(75) Inventors: Chien-Chun Wu, Taichung County (TW); Chien-Jen Li, Taichung County (TW); Cheng-I Teng, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/328,251

(22) Filed: Jan. 10, 2006

(51) Int. Cl. H02J 7/00

(52) U.S. Cl. 320/104

(57) ABSTRACT

A battery charger includes a first housing for holding a battery pack of a power hand tool to be charged, a second housing pivoted to the first housing and provided with a connector connectable to a power socket of a vehicle, a charging unit installed in the first housing and electrically connected to the connector for charging the inserted battery pack, a fastening device for locking the second housing to the first housing after adjustment of the angular position of the second housing relative to the first housing, and a spring member for holding the fastening device in the locking position.

### BACKGROUND OF THE INVENTION

1. Field of the Invention

The present invention relates generally to a battery charger and more particularly, to such a battery charger that is to be used in a motor vehicle to charge the battery pack of a power hand tool.

2. Description of the Related Art

Various battery-operated power hand tools are commercially available. When the battery power of the battery pack of a power hand tool is low, the battery pack must be charged to the saturated status. When charging the battery pack of a power hand tool outdoors, the user may directly install the battery charger in the power socket for cigarette lighter of a motor vehicle to obtain the necessary working voltage from the car battery.

A conventional battery charger for charging a battery pack for power hand tool is known comprising a housing, which defines an accommodation chamber for receiving the battery pack to be charged, a connector fixedly provided at one end of the housing, a charging unit mounted inside the housing and electrically connected to the connector for charging the battery pack inserted into the accommodation chamber of the housing. According to this design, the user cannot adjust the angular position of the housing relative to the connector. After installation of the battery charger in the power socket for cigarette lighter in a motor vehicle, the gearshift lever of the motor vehicle may interfere with the insertion of the battery pack into the accommodation chamber of the housing.

### SUMMARY OF THE INVENTION

The present invention has been accomplished under the circumstances in view. It is therefore the main object of the present invention to provide a battery charger, which can be adjusted to different installation angles to prevent interference of the gearshift lever when installed in the power socket for cigarette lighter in a motor vehicle for charging a battery pack for power hand tool.

To achieve this object of the present invention, the battery charger for use in a vehicle for charging a battery pack of a power hand tool comprises a first housing, a second housing, a charging unit, a fastening device and a spring member. The first housing has an accommodation chamber for receiving a battery pack, a coupling portion, and a positioning portion provided at the coupling portion. The second housing has a connector electrically connectable to a power socket of a vehicle, a coupling portion pivotally coupled to the coupling portion of the first housing for allowing biasing of the second housing relative to the first housing, and a positioning portion. The charging unit is mounted in one of the first housing and the second housing for charging the battery pack accommodated in the accommodation chamber. The charging unit comprises a circuit board provided with a charging circuit, and a set of contact terminals electrically connected to the charging circuit and protruding into the accommodation chamber for the contact of the electrodes of the battery pack inserted into the accommodation chamber. The fastening device is mounted in the connection point between the coupling portion of the first housing and the coupling portion of the second housing and provided with a positioning portion movably coupled to the positioning portion of the second housing, and an engagement portion. The fastening device is movable between a first position where the engagement portion is engaged with the positioning portion of the first housing to lock the second housing to the first housing for prohibiting biasing of the second housing relative to the first housing and a second position where the engagement portion is disengaged from the positioning portion of the first housing for allowing biasing of the second housing relative to the first housing. The spring member is stopped between the first housing and the fastening device to support the fastening device in the first position.

### BRIEF DESCRIPTION OF THE DRAWINGS

FIG. 1 is a perspective view showing a battery pack inserted into a battery charger constructed according to a preferred embodiment of the present invention.

FIG. 2 is an exploded view of FIG. 1.

FIG. 3 is a sectional view of the present invention, showing the locating bolt in the first position.

FIG. 4 is another sectional view of the present invention, showing the locating bolt moved to the second position.

FIG. 5 is a perspective view of the present invention, showing an adjustment example of the battery charger.

FIG. 6 is another perspective view of the present invention, showing another adjustment example of the battery charger.

### DETAILED DESCRIPTION OF THE INVENTION

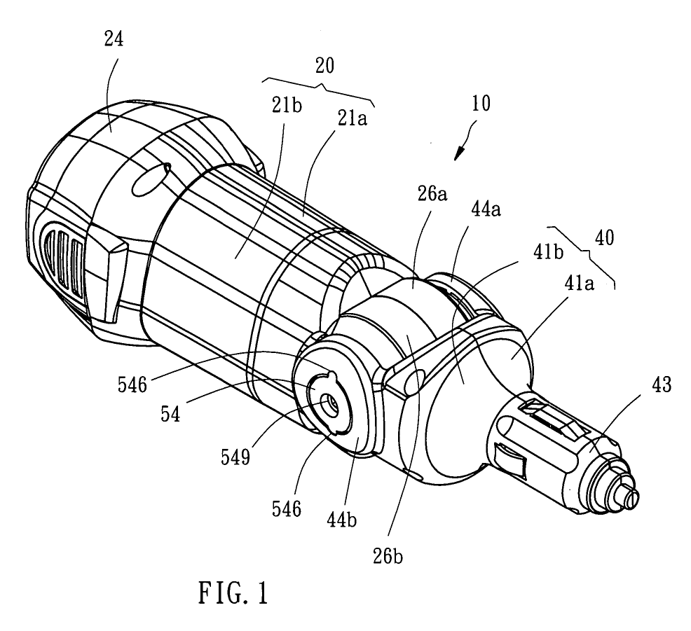

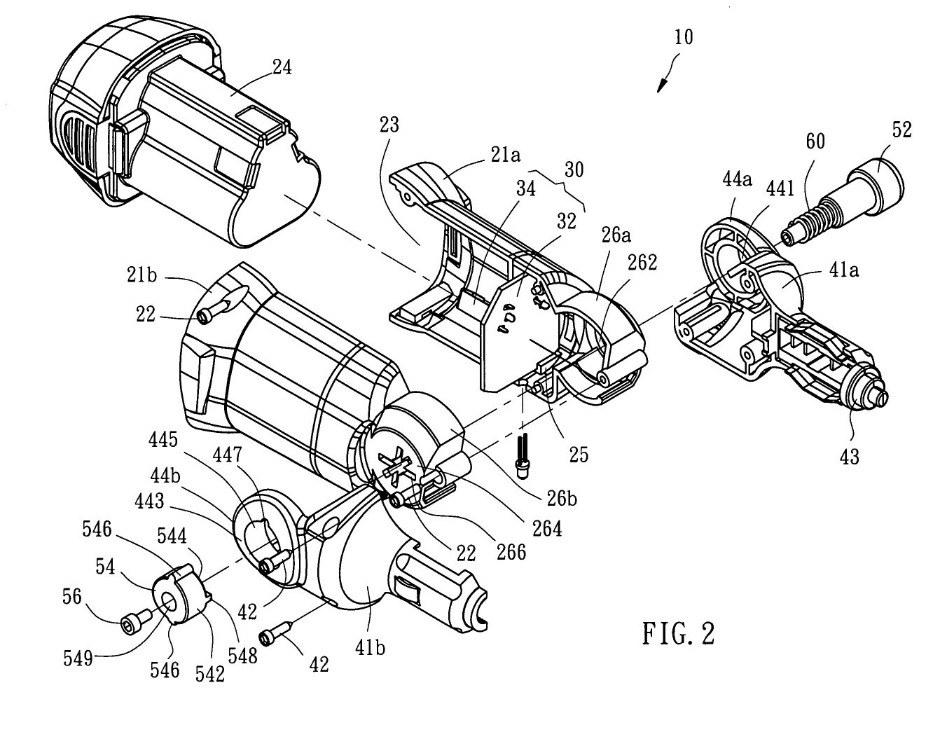

As shown in FIGS. 1 and 2, a battery charger 10 in accordance with the preferred embodiment of the present invention comprises a first housing 20, a charging unit 30, a second housing 40, a fastening device 50, and a spring member 60.

The first housing 20 comprises two half shells 21a and 21b. The two half shells 21a and 21b are abutted against each other and affixed together with screws 22, such that an accommodation chamber 23 is defined therein for accommodating a battery pack 24 for power hand tool to be charged. After insertion of a battery pack 24 into the accommodation chamber 23, a part of the inserted battery pack 24 exposes to the outside of the first housing 20. The two half shells 21a and 21b each have an elongated locating groove 25 corresponding to each other, a coupling portion 26a or 26b at one end, namely, the front end. The coupling portion 26a of one half shell 21a has a through hole 262. The coupling portion 26b of the other half shell 21b has a positioning portion 264. According to this embodiment, the positioning portion 264 comprises a plurality of rectangular locating slots 266 radially arranged in communication with one another.

The charging unit 30 can be installed in the first housing 20 or the second housing 40. According to this embodiment, the charging unit 30 is provided inside the first housing 20. The charging unit 30 comprises a circuit board 32 provided with a charging circuit (not shown) and fastened to the elongated locating grooves 25 in the two half shells 21a and 21b of the first housing 20, and a set of contact terminals 34 electrically connected to the charging circuit of the circuit board 32 and projecting into the accommodation chamber 23 of the first housing 20 for the contact of the electrodes of the battery pack 24 that is inserted into the accommodation chamber 23.

The second housing 40 is comprised of two half shells 41a and 41b. The two half shells 41a and 41b are abutted against each other and fastened together with screws 42 so as to form a front connector 43 insertable into the power socket for cigarette lighter of a motor vehicle. The two half shells 41a and 41b each have a circular-like coupling portion 44a or 44b disposed at the rear side and respectively pivotally coupled to the coupling portions 26a and 26b of the first housing 20, allowing biasing of the second housing 40 relative to the first housing 20 within a predetermined angle. Further, the rectangular locating slots 266 are radially arranged around the pivot point between the coupling portions 40a and 40b of second housing 40 and the coupling portions 26a and 26b of the first housing 20, Further, the coupling portion 44a of one half shell 41a of the second housing 40 has a through hole 441. The coupling portion 44b of the other half shell 41b of the second housing 40 has a positioning portion 443. The positioning portion 443 according to this embodiment comprises a positioning hole 445, which is coaxially disposed in alignment with the through hole 441 and the center of axis of the coupling portions 26a and 26b of the first housing 20, and two locating grooves 447 respectively formed at the top and bottom sides of the annular wall that surrounds the positioning hole 445.

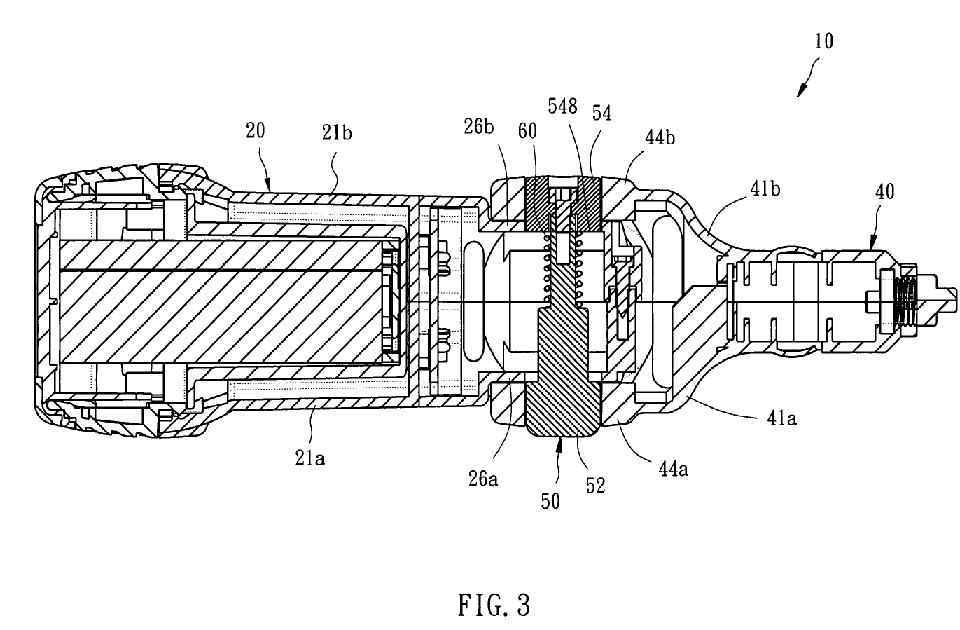

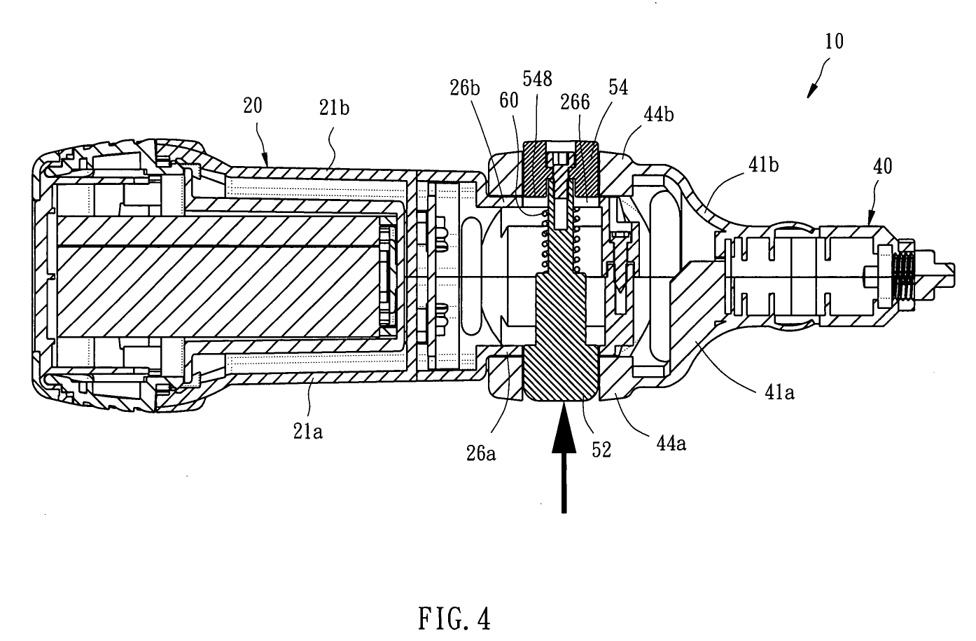

Referring to FIGS. 3 and 4, the fastening device 50 comprises a locating bolt 52 and a stop block 54. The locating bolt 52 is inserted in proper order through the through hole 441 of the coupling portion 44a and the through hole 262 of the coupling portion 26a into the coupling portion 26b of the half shell 21b, and axially movable relative to the housings 20 and 40 between a first position and a second position. The stop block 54 is inserted into the positioning hole 445 of the coupling portion 44b of the half shell 41b of the second housing 40. The stop block 54 has a positioning portion 542 and an engagement portion 544. According to this embodiment, the positioning portion 542 is provided with two locating ribs 546 respectively protruded from the top and bottom sides of the stop block 54 and respectively engaged into the locating grooves 447 of the coupling portion 44b of the half shell 41b of the second housing 40. The engagement portion 544 is provided with an engagement rib 548 selectively engaged into the locating slots 266. The stop block 54 further has a center through hole 549 cut through the front and back sides thereof. A screw 56 is mounted in the center through hole 549 of the stop block 54 and threaded into one end of the locating bolt 52 to fasten the stop block 54 and the locating bolt 52 together. When the locating bolt 52 is in the first position as shown in FIG. 3, the engagement rib 548 is engaged into the locating slots 266 to stop the second housing 40 from biasing relative to the first housing 20. When the locating bolt 52 is in the second position as shown in FIG. 4, locating bolt 52 holds the stop block 54 in such a position that the engagement rib 548 is disengaged from the locating slots 266, allowing biasing of the second housing 40 relative to the first housing 20.

The spring member 60 according to this embodiment is a compression coil spring sleeved onto the locating bolt 52 and stopped between a part of the locating bolt 52 and one half shell 21b of the first housing 20. The spring member 60 imparts an outward pressure to the locating bolt 52, supporting the locating bolt 52 in the first position. When moved the locating bolt 52 to the second position, the spring member 60 is compressed.

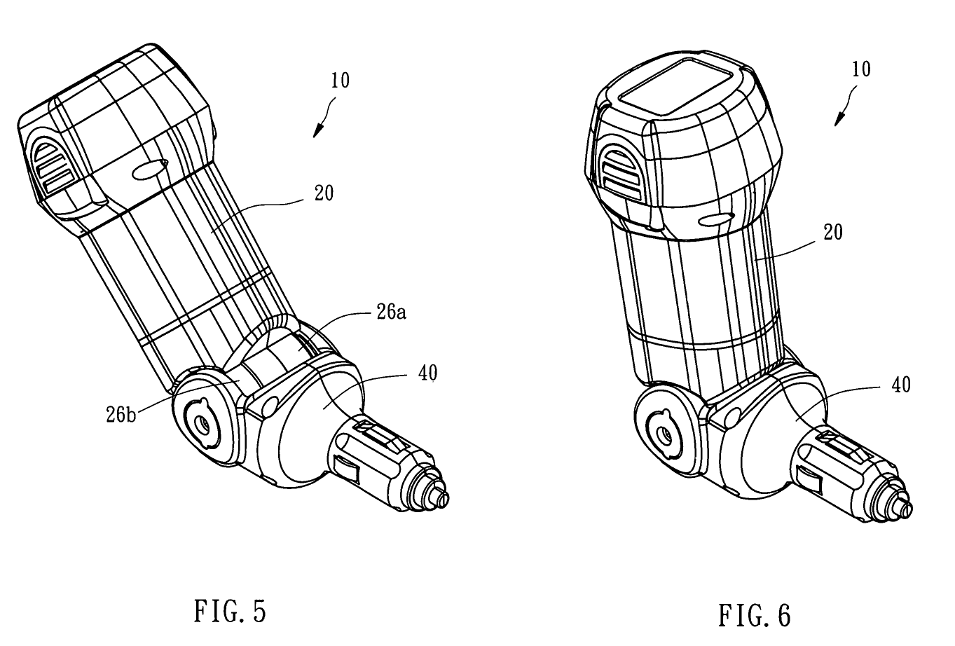

When wishing to adjust the angular position of the battery charger 10, press the locating bolt 52 against the spring member 60 to move the locating bolt 52 from the first position to the second position and to further disengage the stop block 54 from the locating slots 266 as shown in FIG. 4, and then bias the second housing 40 relative to the first housing 20 to the desired angle, and then release the hand from the locating bolt 52, allowing the spring member 60 to push the locating bolt 52 backwards to the first position as shown in FIG. 3, and therefore the locating rib 548 of the stop block 54 is moved into engagement with the locating slots 266 again to fasten the second housing 40 to the first housing 20 as shown in FIGS. 5 and 6.

As indicated above, the battery charger 10 allows the user to adjust the angular position of the second housing 40 relative to the first housing 20 so that when the connector 43 is connected to the power socket for cigarette lighter in a motor vehicle, the gearshift lever does not interfere with the installation of a battery pack in the battery charger 10 for charging.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A battery charger for use in a vehicle for charging a battery pack of a power hand tool, the battery charger comprising:
a first housing having an accommodation chamber for receiving a battery pack to be charged, a coupling portion, and a positioning portion provided at the coupling portion;
a second housing having a connector electrically connectable to a power socket of a vehicle, a coupling portion pivotally coupled to the coupling portion of said first housing for allowing biasing of said second housing relative to said first housing, and a positioning portion;
a charging unit mounted in one of said first housing and said second housing for charging the battery pack accommodated in said accommodation chamber, said charging unit comprising a circuit board provided with a charging circuit, and a set of contact terminals electrically connected to said charging circuit and protruding into said accommodation chamber for the contact of the electrodes of the battery pack inserted into said accommodation chamber;
a fastening device mounted in a connection point between the coupling portion of said first housing and the coupling portion of said second housing and provided with a positioning portion movably coupled to the positioning portion of said second housing, and an engagement portion; wherein said fastening device is movable between a first position where said engagement portion is engaged with the positioning portion of said first housing to lock said second housing to said first housing for prohibiting biasing of said second housing relative to said first housing and a second position where said engagement portion is disengaged from the positioning portion of said first housing for allowing biasing of said second housing relative to said first housing; and
a spring member stopped between said first housing and said fastening device to support said fastening device in said first position.

2. The battery charger as claimed in claim 1, wherein the positioning portion of said first housing is provided with a plurality of locating slots; the engagement portion of said fastening device is provided with an engagement rib selectively engageable into said locating slots.

3. The battery charger as claimed in claim 2, wherein said locating slots are radially arranged around the connection point between the coupling portion of said first housing and the coupling portion of said second housing.

4. The battery charger as claimed in claim 3, wherein said locating slots are disposed in communication with one another.

5. The battery charger as claimed in claim 1, wherein the positioning portion of said second housing is provided with a positioning hole for insertion of said fastening device.

6. The battery charger as claimed in claim 5, wherein the positioning portion of said second housing is further provided with two locating grooves spacedly arranged in communication with the positioning hole; the positioning portion of said fastening device is provided with two locating ribs movably respectively inserted into the locating grooves of the positioning portion of said second housing.
